(19) United States
(12) Patent Application Publication
(10) Pub. No.: US 2003/0183026 A1
(43) Pub. Date: Oct. 2, 2003

(54) Apparatus for converting rotary to reciprocating motion and vice versa

(76) Inventors: Alexsandr Y. Korniyenko, Plymouth, MN (US); Valeriy Y. Kostraba, Eden Prairie, MN (US)

Correspondence Address: James V. Harmon, 1000 Northstar Center East, 608 Second Avenue South, Minneapolis, MN, 55402, US

(21) Appl. No.: 10/109,352

(22) Filed: Mar. 29, 2002

(51) Int. Cl. F16H 21/18

(52) U.S. Cl. 74/49

(57) ABSTRACT

An apparatus for achieving a transfer between rotary and reciprocating motion includes a supporting framework, and a crankshaft mounted for rotation within a fixed bearing on the framework. A circular, fixed sun element is centered on the axis of the crankshaft. A circular planetary element is mounted for rotation on the free end of the crank arm with a connecting rod rigidly connected between the planetary element and a wrist pin that is rotably connected to a piston rod which is in turn supported for rectilinear reciprocation. A drive means e.g., a chain, belt, gear or mechanical coupling is operatively connected between the sun element and the planetary element for rotating the connecting rod in the opposite direction from the crankshaft to thereby impart back and forth motion to the piston rod as the planetary element revolves in one direction and rotates in the opposite direction.

### FIELD OF THE INVENTION

This invention relates to mechanical devices and more particularly to machines that convert transillatory or rectilinear motion to rotary motion and vice versa.

### BACKGROUND OF THE INVENTION

Many previous engines, compressors, pumps and other devices for converting rotary motion to reciprocating motion or reciprocating motion to rotary motion have been subject to vibration and cross loading or are expensive to produce. Virtually all are limited to a relatively short stroke that equals the length of the crank arm.

In view of these and other deficiencies of the prior art it is one object of the invention to provide a device of a type described which efficiently converts rotary to reciprocating motion or the latter to rotary motion and which is rugged in construction, reliable in operation and economical to manufacture.

Another more specific object is to provide a longer stroke than a conventional connecting rod that is connected in the usual way between a reciprocating mass and a crankshaft.

Still another object is to provide a mechanism of a character described in which there is virtually no cross loading of the reciprocating mass.

Yet another object of the invention is to provide a mechanism of a character described which is well suited for a variety of applications including compressors, pumps, farm implements, internal combustion engines, hydraulic and air motors, refrigerators, heat exchangers, heat pumps and the like.

A further object is to provide a device of a type described which is characterized by the absence of any added loads, the possibility of complete balance when four or a multiple of four of the devices are unified in one frame and the ability to increase piston stroke while reducing the overall size of the. device by delivering twice the piston stroke of a conventional engine with a crankshaft of the same size.

These and other more detailed and specific objects of the present invention will be better understood by reference to the following figures and detailed description which illustrate by way of example but a few of the various forms of the invention within the scope of the appended claims.

### BRIEF DESCRIPTION OF THE DRAWINGS

FIGS. 1-4 are similar top perspective views showing the invention in successive stages of operation proceeding from FIG. 1 to FIG. 4 and specifically:

FIG. 1 is a top perspective view showing the reciprocating mass at the right end of its stroke.

FIG. 1A is a horizontal partial sectional view taken on line 1A-1A of FIG. 1.

FIG. 2 shows the reciprocating mass as it begins to move toward the left of the Figures.

FIG. 3 shows the pistons and connecting rod at the left end of their stroke,

FIG. 4 shows the connecting rod and pistons at midpoint returning toward the right and,

FIG. 5 is a partial longitudinal cross-sectional view similar to FIG. 1A but on a larger scale in which a connecting member between the sun and planetary elements is a gear.

FIG. 6 is a view similar to FIG. 5 showing a different sun element.

### SUMMARY OF THE INVENTION

An apparatus is described for achieving a transfer between rotary and reciprocating motion that has a supporting framework with a crankshaft and a crank arm which is mounted for rotation within a fixed bearing on the framework. A circular, fixed sun element is centered on the axis of the crankshaft. A circular planetary element is mounted for rotation on the free end of the crank arm and a connecting rod is rigidly connected between the planetary element and a wrist pin which is rotably connected to a piston rod that is in turn supported for rectilinear reciprocation. A connecting means e.g., belt, chain, gear or direct coupling is operatively engaged between the sun element and the planetary element for rotating the connecting rod in a direction opposite that of the crankshaft to thereby impart back and forth motion to the piston rod. In other applications, the back and forth motion of piston and piston rod is used to impart rotation to the crankshaft.

### DETAILED DESCRIPTION OF THE INVENTION

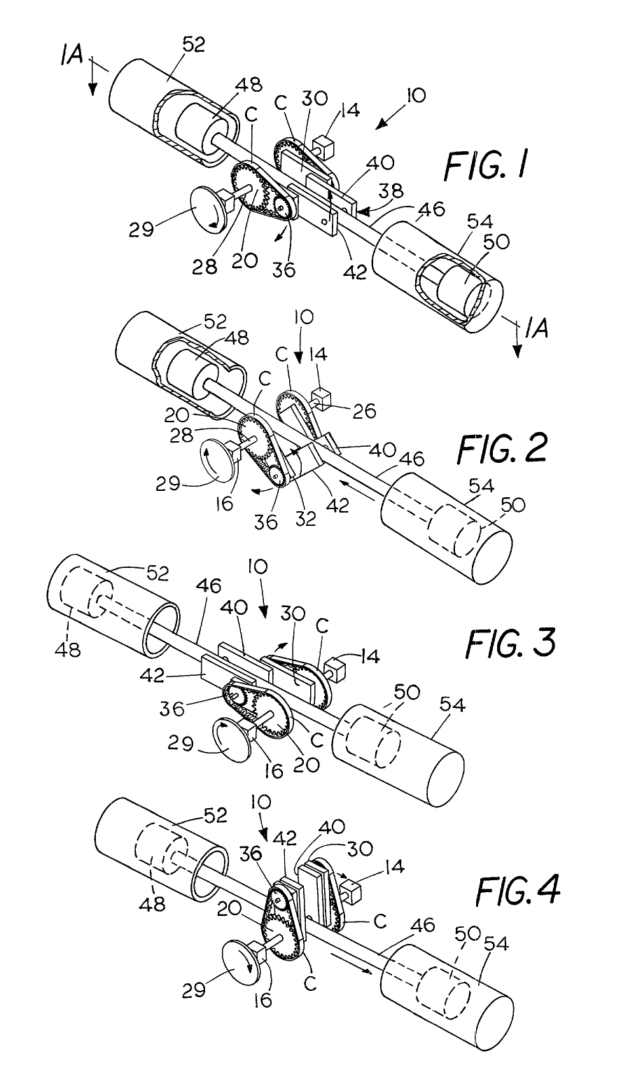

Refer first to FIGS. 1-4. The apparatus indicated generally at 10, includes a fixed supporting base 12 with integral i.e., fixed bearing blocks 14 and 16 and a pair of fixed axially aligned sun elements 18 and 20 that can, if desired, be connected to the blocks 14, 16 by stationary sleeves 22, 24 (FIG. 1A). Aligned crankshafts 26 and 28 are journaled for rotation in blocks 14, 16 and include aligned crank arms 30, 32 with aligned bores at their free ends which support the shafts of aligned planetary elements, 34, 36 each having a diameter that is half the diameter of the sun elements 18, 20.

When it would be beneficial, an optional inertial mass comprising a flywheel 29 can be affixed to the crankshaft 26 or 28 to smooth out the movement and help carry crank motion past top and bottom dead center positions.

Each of the planetary elements 18 and 20 is coupled to its cooperating sun element with a connecting member e.g., a chain or timing belt C. The planetary elements or sprockets 34, 36 are rigidly connected together by a generally U-shaped connecting rod 38 having two aligned arm portions 40, 42 with a transversely extending wrist pin 44 supported therebetween for rotation in a transverse bore provided in a piston rod 46 to which pistons 48 and 50 are rigidly connected for reciprocatory motion within stationary cylinders 52 and 54. The cylinders can be pump cylinders as in a pump or compressor in which rotary motion of the crankshaft 26, 28 and flywheel 29 is converted to reciprocatory motion. In other applications, the cylinders are engine cylinders e.g., in a gasoline engine, diesel engine, a compressed air or hydraulic motor in which case reciprocating motion is converted to rotary motion.

The distance L (FIG. 1A) between the axis of crankshafts 26, 28 and the axis of the planetary sprockets 34, 36 is equal to L′ the distance between the center of the planetary element 34, 36 and the wrist pin 34. If desired, the piston rod 46 which will undergo pure linear motion can be supported in a slide bearing or by a crosshead (not shown).

During operation, as the crankshaft 26, 28 turns clockwise 180° (from the position of FIG. 1 to that of FIG. 3) the planetary elements 34, 36 and connecting rod assembly 38 will necessarily rotate a full 360° but in the reverse direction (counter clockwise to the position of FIG. 3) thus causing the connecting rod 46 to reciprocate with a stroke in each direction of 2L i.e., twice the throw of the crankshaft, which equals the sum of L plus L′.

If desired, for certain applications e.g., farm equipment, no piston is needed and in others only a single piston is used. If a more compact design is required for some applications, all of the parts shown in FIG. 1A above the wrist pin 44 (parts 12, 14, 18, 22, 26, 30, 34, and 40) can be eliminated.

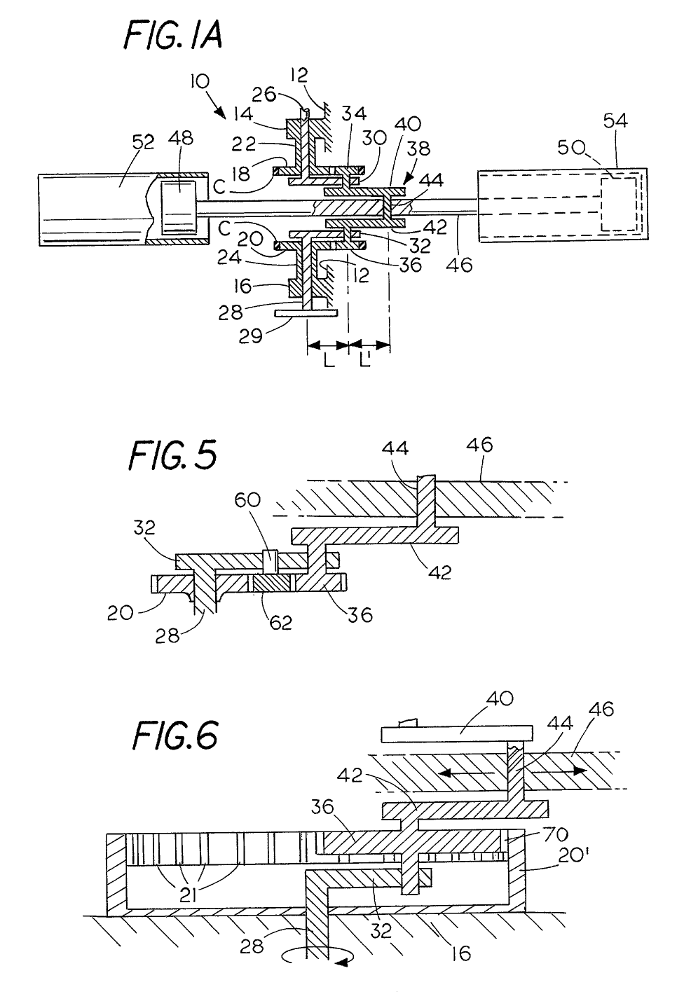

Refer now to FIG. 5 which illustrates a modified form of the invention wherein the same numerals refer to corresponding parts already described. FIG. 5 illustrates how the connecting member C which can be a chain or timing belt has been replaced by a gear. The sun element 20 and planetary element 36 in this case both comprise spur gears, the latter having half the number of teeth of the sun gear 20. Journaled for rotation at 60 upon the crank arm 32 and engaged between the gears 20 and 36 is an idler gear 62 which imparts rotation to the planetary gear 36 as the crank arm 32 rotates. During operation, as the crankshaft 28 rotates, the rotation of the idler gear 62 imparts rotation to the planetary gear 36 opposite the direction of rotation of the crankshaft 28 to thereby impart rectilinear reciprocating motion to the piston rod 46.

In FIG. 6, wherein the same numerals refer to parts already described, the sun element 20′ is an internal ring gear and the means connecting the sun 20′ and planet element is a direct mechanical connection of the teeth of the sun 20′ and planet gear 36, for example, at 70 so as to rotate the planet gear 36 as it is revolved in a circle by the crank arm 32 thereby imparting back and forth motion to the piston rod 46 in the manner described above. As already noted, the stroke of the crank arm 32 equals that of the connecting rod 40, 42 the planet gear 36 has half the number of teeth as the sun 20′.

The invention is positive in its action so as to reliably impart rectilinear reciprocating motion to the connecting rod and pistons. Moreover, for every rotation of the crankshaft there are two linear extensions of the piston rod. In addition, the stroke of the piston rod in each direction is twice of the stroke of a crankshaft in each direction. Furthermore, there is virtually no cross loading of the piston rod.

The invention is highly effective in achieving a transfer between rotating and reciprocating motion, that is, in converting one form of energy to another. It is also well suited for a wide range of possible applications including compressors, pumps, farm implements, internal combustion engines, hydraulic motors, air motors and so on. It does not impart any added loads. In addition, it affords the possibility of complete balance in a design if several units embodying the invention are integrally connected together on the same crankshaft and unified in one framework. The invention also provides the opportunity to increase the piston stroke while maintaining an overall reduction in engine size because the invention delivers twice the piston stroke of a conventional engine with a crankshaft of the same size.

Many variations of the present invention within the scope of the appended claims will be apparent to those skilled in the art once the principles described herein are understood.

What is claimed is:

1. An apparatus for achieving a transfer between rotary and reciprocating motion comprising,
a crankshaft mounted for rotation about an axis on a fixed bearing, said crankshaft having a crank arm,
a fixed circular sun element centered upon the axis of the crankshaft,
a circular planetary element one half the diameter of the sun element mounted for rotation on a free end of the crank arm,
a connecting rod rigidly connected between the planetary element and a wrist pin that is rotably connected to a piston rod which is in turn supported for rectilinear reciprocation thereon, and
a connecting means is operatively engaged between the sun element and the planetary element for rotating the planetary element to thereby impart reciprocation to the piston rod.

2. The apparatus of claim 1 wherein at least one piston is connected to the piston rod and the distance between the axis of the sun and planetary element equals the distance between the axis of the planetary element and the wrist pin.

3. The apparatus of claim 1 including two aligned crankshafts, two sun elements, two planetary elements, two crank arms and two connecting rods proximate the piston rod and the free ends of the connecting rods are connected to the wrist pin on opposite sides of the piston rod.

4. The apparatus of claim 1 wherein motive power means is connected to the crankshaft for imparting reciprocation to the piston rod.

5. The apparatus of claim 2 wherein a force is applied to the piston to reciprocate the piston so as to thereby impart rotation to the crankshaft.

6. The apparatus of claim 1 wherein the sun and planetary elements are sprockets and the connecting member is a timing belt or chain.

7. The apparatus of claim 1 wherein the sun and planetary elements are gears and the connecting member is an idler gear coupled therebetween.

8. The apparatus of claim 1 wherein the sun and planetary elements are gears and the sun is an internal ring gear and the planetary gear is engaged therewith.

9. The apparatus of claim 2 wherein the piston rod comprises an elongated rod having the wrist pin connected proximate a center point thereon, said piston is connected to one end thereof and a second piston is connected to an opposite end thereof.

10. The apparatus of claim 9 wherein each piston is slideably mounted in a cylinder.

11. The apparatus of claim 2 wherein the piston is mounted in a cylinder.

12. The apparatus of claim 10 wherein the apparatus is an air motor, a hydraulic motor or internal combustion engine.

13. The apparatus of claim 11 wherein the apparatus is an air motor, a hydraulic motor, or internal combustion engine.

14. The apparatus of claim 10 wherein the apparatus is a fluid pump or compressor.

15. The apparatus of claim 11 wherein the apparatus is a pump or compressor.

16. An apparatus for achieving a transfer between rotary and reciprocating motion comprising,
a pair of aligned crankshafts mounted for rotation about an axis on fixed bearings, each crankshaft having a crank arm,
a pair of aligned fixed circular sun elements centered upon the axis of the crankshafts,
a pair of aligned circular planetary elements one half the diameter of the sun elements mounted for rotation on a free end of the crank arm,
a pair of aligned connecting rods rigidly connected between the planetary elements and a wrist pin that is rotably connected to a piston rod which is in turn supported for rectilinear reciprocation thereon, and
a pair of aligned connecting means operatively engaged between the sun elements and the planetary elements for rotating the planetary elements to thereby impart reciprocation to the piston rod.

17. The apparatus of claim 16 wherein a piston is connected to each end of the piston rod.

18. The apparatus of claim 16 wherein each sun element is an internal ring gear and each connecting means is a direct coupling between each planetary element and the internal ring gear.
